(19) United States
(12) Patent Application Publication
(10) Pub. No.: US 2008/0052749 A1
(43) Pub. Date: Feb. 28, 2008

(54) Managing Stored Service Information

(75) Inventor: David J. Woolgar, Horsham (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,135

(22) PCT Filed: Sep. 15, 2005
(86) PCT No.: PCT/IB05/53030

§ 371 Date: Mar. 13, 2007

(30) Foreign Application Priority Data
Sep. 18, 2004 (GB) 0420814.6

(51) Int. Cl. H04N 7/173

(52) U.S. Cl. 725/105

(57) ABSTRACT

A method for managing SI (Service Information) data stored within a receiver operable to receive digital AV (audio visual) content. The method comprises receiving (104) an SI data item; obtaining (106) the time of receipt and then storing (110) the data item and time of receipt. Concurrently, for each stored SI data item, the time of receipt of a stored SI data item is read (114); its age calculated (116) and compared (120) with a reference value; the stored SI data item is deleted (122) in dependance on the comparison. In this way obsolete data can be removed from the database without also removing valid data. By using a range of reference values according to the various types of SI data items, removal of obsolete data items can be further optimised to minimise the size of the database and reduce the likelihood of overlapping data items therein.

The present invention relates to managing data within a database and in particular managing Service Information (SI) data stored within a receiver for receiving digital AV (audio visual) content.

Digital television is becoming widely deployed. Like prior analogue television systems, distribution of digital television can be achieved using satellite, terrestrial or cable methods, and also future methods such as broadband Internet. However, unlike analogue television, there can be a number of services transmitted (multiplexed) in a particular transmission channel. Furthermore, a receiver may be able to receive several such transmission channels (multiplexes) and needs to readily identify services conveyed by these channels.

Digital television delivery mechanisms typically include metadata which compatible receivers use to identify, acquire and navigate the various services available to them. Such metadata is termed herein as Service Information (SI) data and is not limited to any particular digital television delivery system.

An example can be found within the Digital Video Broadcasting (DVB) project which has defined Service Information (SI) data to describe the services (e.g. TV channels) provided and on which transmission channels these are conveyed. The SI data is composed of a set of tables of different types, each table containing data relating to a specific service aspect, for example a Network Information Table (NIT) describes grouping of transport streams (TS) and relevant tuning information. An exemplary type of table is Event Information Tables which contain information about present, following and other future events (e.g. TV shows).

The contents of a SI table may change over time, for example the content of an Event Information Table (EIT) in which the details of one or more events described in the table has changed. To signal changed content, each SI table has an associated version number which is incremented each time the content of the table is changed. The intention is that a receiver, for each table it receives, will monitor the version number and ensure the table with the most up to date version number is stored. Unfortunately, this mechanism can be inefficient in that the version number is updated for even minor changes. As an example, for an EIT a change might be to the starting time of an event, or the relative days (compared to the current day) to which the respective table refers. As a result of detecting a new version, the respective entire table must be re-acquired and stored since none of the data of the original table can be relied upon (since the data item or items that have actually changed within the table are not explicitly identified). Typically, for an EIT schedule table this involves the re-acquisition of four days of event information. Under certain routine situations, the version number of an EIT may be changed even though its underlying event data has not changed; one such example is at midnight (day boundary) for EIT tables. In such cases re-acquisition is required even though all the event data is probably unchanged and reliable. A further issue is that SI tables containing the same or similar data may be available to the receiver from several sources (transmission channels); the version numbers of such tables are typically not coordinated and therefore the receiver is unable to determine the correct (for example, the most up to date EIT) table to acquire and use unless it tracks the version numbers for each EIT across all multiplexes which is a cumbersome task. A common outcome is that signalling changes using version numbering condemns useable (trustworthy) data which could otherwise be still available for use by the receiver.

It is an object of the present invention to provide a method to improve the management of stored SI data delivered using existing SI data transmission protocols.

In accordance with the present invention there is provided a method for managing SI data stored within a receiver operable to receive digital AV content, the method comprising:
receiving an SI data item;
obtaining the time of receipt of the SI data item;
storing the SI data item and its time of receipt; and
concurrently, for each stored SI data item:
   reading the time of receipt of the stored SI data item;
   calculating the age of the stored data item;
   comparing the calculated age with a reference value; and
   deleting the stored SI data item and its time of receipt in dependence on the comparison.

The present invention stems from the realisation that by associating time of receipt with an item of received SI data, an SI data item greater than a certain age can be purged from the receiver database thereby retaining only up-to-date data within the database. Furthermore, the method does not utilise or rely on the SI table version number mechanism. For example, in DVB based systems, a large SI data table is partitioned and sent to a receiver by means of MPEG sections within a plurality of transport packets in the transport stream. In this example, a received SI data item is contained within the payload data of an MPEG section obtained from a transport packet, the header data of the MPEG section identifying to which SI table the payload data belongs. In this way, suitably recent receipt of a particular SI data item is sufficient to ensure that the particular SI data item is reliable. The method ensures that an unchanged SI data item already acquired remains both reliable and continuously available to the receiver even when the broadcaster indicates that one or more changes have occurred to the SI table containing that (unchanged) SI data item. This has performance advantages for a receiver, for example consistent fast presentation of an Electronic Programme Guide (EPG) to a user.

Advantageously, any suitable means may be used to determine the reference value used to decide whether to delete a stored data item. An arbitrary time period may be used for the reference value. For example a period of 15 minutes would ensure that data not updated within this time period is deleted from the database. For example an EIT table previously containing data relating to a TV show, when the show finished the EIT table could be updated to no longer contain the TV show data and the version number of the table would be incremented. To transmit the update a revised EIT table with a new version number would be transmitted, except there would be no SI data item (event data) transmitted for the completed show. In prior art receivers, the entire EIT table would be re-acquired; in a receiver according to the present invention, the database record for the deleted show would ‘expire’ and the corresponding event data thereby deleted. Clearly, the choice of time period will depend on a balance between keeping old data too long in the database (resulting in a larger than necessary storage requirement in the receiver and the possibility of having overlapping data) and the rate at which data is typically resent (carouselled) by the broadcaster—too short a period will risk deleting data that is still valid with consequent effects on receiver performance (for example delay in presenting EPG to the viewer). A period of 15 minutes is proposed in order, on the one hand, to sufficiently exceed the recommended slowest data resend rate (for example in a DVB based system this can be up to 300 seconds for an EIT schedule table) thereby reducing the likelihood of deleting valid data, and, on the other hand, to be suitable for events having a typical duration of 30 minutes thereby reducing the likelihood of the database containing overlapping data for an event.

As an improvement, the time period may be determined according to the type of SI data item, for example EIT Schedule table data for the actual TS. The DVB Guidelines define minimum repetition rates for a specified subset of SI tables; for remaining SI data tables, the Guidelines recommend practicable repetition rates. Such rates may be used to determine a reference value, preferably per identified SI table type. Such methods will help reduce the database storage requirement, compared to use of a single reference value described earlier.

Preferably, to determine a suitable reference value, the receiver can measure the time interval between successive receptions of an identified SI data item (e.g. MPEG section containing the identified SI data item). This approach helps optimise database storage capacity used in the receiver for storing SI data according to prevailing rate of received SI data.

According to a second aspect of the present invention, there is provided a system for managing SI data according to the method of the invention, the system comprising:
a transmitter operable to transmit SI data; and
a receiver operable to:
   receive an SI data item;
   obtain the time of receipt of the SI data item;
   store the SI data item and its time of receipt; and
   concurrently, for each stored SI data item:
      read its time of receipt;
      calculate the age of the stored data item;
      compare the calculated age with a reference value; and
      delete the stored SI data item and its time of receipt in dependence on the comparison.

According to a third aspect of the present invention, there is provided a receiver for use in the system of the invention, comprising:
a tuner operable to receive SI data items;
a clock;
a data store operable to store received SI data items and, for each data item, its time of receipt;
a program store operable to store program instructions; and
a processor, all interconnected by a data and control bus, the processor being operable, under control of the program instructions, to:
   receive an SI data item from the tuner;
   obtain time of receipt of the SI data item from the clock;
   store the SI data item and its time of receipt in the data store; and
   concurrently, for each stored SI data item:
      read its time of receipt from the data store;
      calculate the age of the stored data item;
      compare the calculated age with a reference value; and
      delete the stored SI data item and its time of receipt from the data store in dependence on the comparison

To summarise, the method of the present invention provides a convenient means using existing transmission digital television protocols to manage a database of stored SI data in a receiver by identifying SI data items which are deemed to be no longer transmitted and therefore can be deleted, thereby optimising database storage requirement. Furthermore, data items presently stored in the database are trusted (as their resending is continuously monitored) and are therefore available for use by the receiver (e.g. for EPG presentation) with confidence without further qualification or re-acquisition, irrespective of SI data table version numbering or from which of one or more TS (multiplex) the SI data is acquired. Furthermore, the method is compatible with any digital services transmission which utilises SI metadata, in particular those based on DVB standards including DVB-S, DVB-C, DVB-T and ATSC.

Embodiments of the invention will now be described, by way of example only, with reference to the accompanying drawings in which:

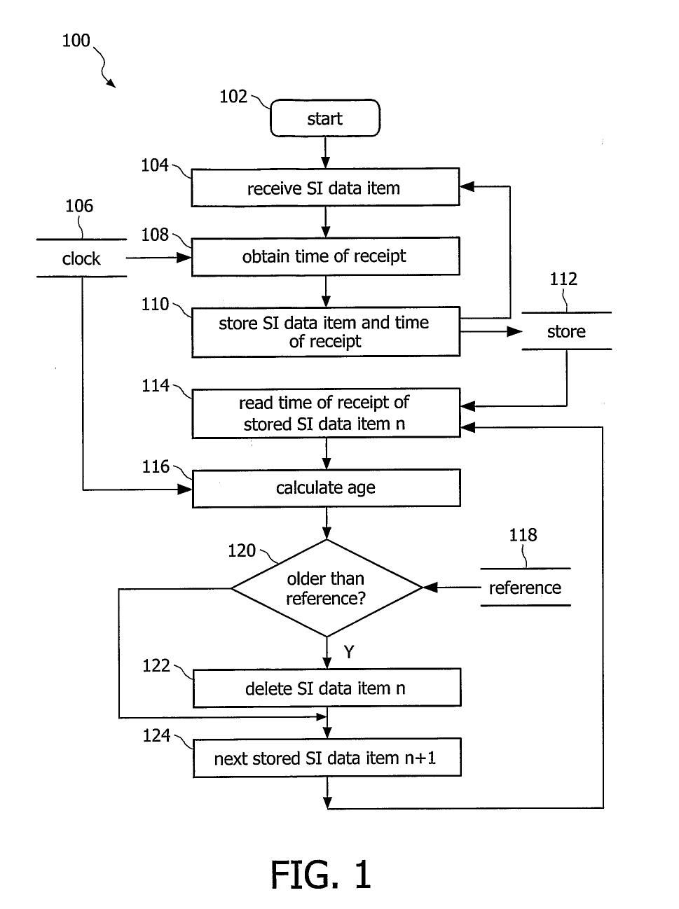

FIG. 1 is a flow diagram of a method for managing SI data stored within a receiver;

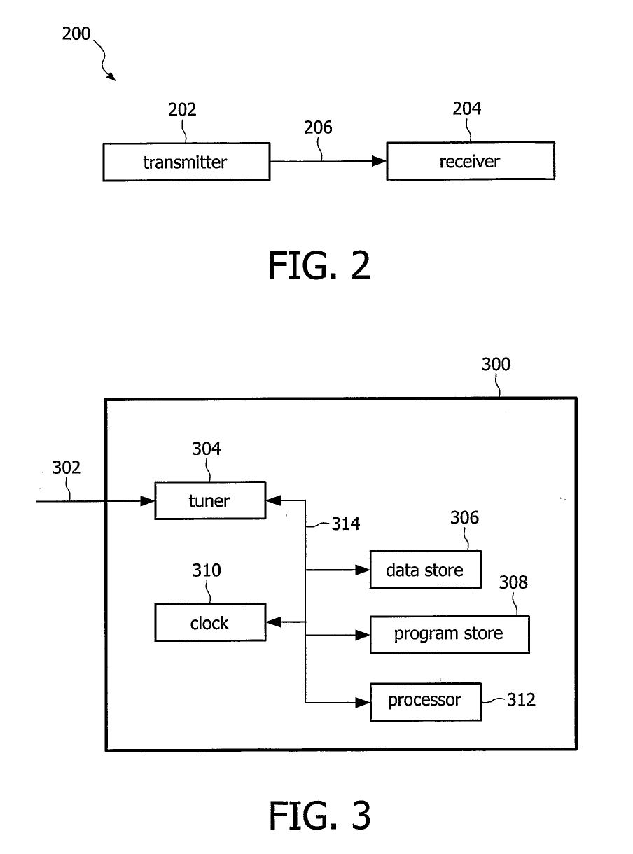

FIG. 2 is a schematic diagram of a system for managing SI data; and

FIG. 3 is a schematic diagram of a receiver for use in the system of FIG. 2.

In the present description, the term ‘SI data item’ refers to metadata delivered to a receiver, the metadata describing one or more aspects of one or more services potentially available to the receiver. The metadata may be used by the receiver to identify, acquire and navigate such services. The term ‘SI data item’ used herein is not limited to any particular digital television delivery system or to the format of Service Information data (metadata) it contains. An example of an SI data item for a DVB based system is any item of SI data delivered to the receiver, for example a data structure such as an SI table, or a data element within an SI table, for example an event within a DVB EIT.

FIG. 1 shows a flow diagram of a method for managing SI data stored within a receiver. The method, shown generally at 100, starts at 102 and, at 104, receives an SI data item. The method then obtains 108 the time of receipt of the SI data item, for example from a clock 106. Any suitable clock may be used such as a local time reference. Preferably, the clock is synchronised with the digital AV transmission as is typical for digital AV receivers. The method continues by storing 110 both the SI data item and time of receipt of the SI data item in store 112. This step provides an easy and efficient way to subsequently determine the age of a stored SI data item. In general, digital AV distribution, such as that defined by the DVB standards, requires that SI data is carouselled; that is, SI data is repeatedly transmitted at defined time intervals. Clearly, obsolete data (such as a past TV show or event) will at some point cease to be transmitted (excluded from the carouselled data). The present invention exploits this aspect to identify a specific data item which has become obsolete, rather than relying on the course version numbering mechanism which indicates, but does not identify, that possibly one or more data items have become obsolete. The method then loops back to receive a further SI data item at 104.

The method further comprises, concurrently with receiving and storing data items, for a stored SI data item ‘n’, reading 114 the time of receipt of the stored SI data item from store 112. The age of the item is calculated 116 with reference to the clock time 106. The calculated age is then compared 120 with a reference value 118. In a preferred implementation, the reference value is selected according to a particular type of SI data item; that is, where there is more than one type of stored SI data item, more than one reference value can be used. Alternatively, one reference value can be used for all types of SI data item. As an example, for SI data item comprising an EIT event, the reference value used can be one of a range of values, each corresponding to the specific EIT the event belongs to since DVB specifies that different EIT tables are carouselled (repeated) at differing time intervals. Alternatively, a single reference value can be used for all SI data items from the different EIT tables. Where the comparison 120 indicates that the SI data item is older than the reference value, the SI data item (and its corresponding time of receipt data) are deleted 122 from the store. The method then refers 124 to next stored data item ‘n+1’ and loops back to read at 114 the time of receipt of stored data item ‘n+1’. Using this, or similar methods readily identifiable to the skilled person, while receiving and storing SI data items, the age of each stored SI data item is compared to a suitable reference value and deleted when too old.

FIG. 2 is a schematic diagram of a system for managing SI data. The system shown generally at 200 comprises a transmitter 202 sending digital AV transport data stream 206 to a receiver 204. Typically the transmitter comprises a terrestrial, satellite, cable or Internet transmission to a population of receivers including receiver 204. The digital AV transport data stream 206 contains AV content and metadata which comprises SI data items. An example of a digital AV transport data stream is one based on DVB standards, such as DVB-S, DVB-T, DVB-C, MHP, MHEG, ASTC and the like, wherein the SI data items are conveyed within DVB based SI tables. The receiver may comprise a STB, iDTV, PC or the like.

FIG. 3 is a schematic diagram of a receiver for use in the system of FIG. 2. Although the following description refers to a receiver 300 which is DVB compliant, the skilled person will recognise that the teaching of the present invention also applies to alternative digital AV content systems employing SI metadata. Referring to FIG. 3, the receiver 300 comprises a tuner 304, a write/read data store 306, program store 308, clock 310 and processor 312 all interconnected by a control and data bus 314; the activities of the receiver being governed by the processor operating under control of a software program held in program store 308, in known fashion. A DVB transport stream (TS, also known as a multiplex) 302 is received by tuner 304. The tuner decodes SI data items contained within the TS and transfers these via bus 314 to the processor. Some received SI data items concern time and date information which the processor 312 uses to synchronise the clock 310. Other received SI data items relate to events (for example TV shows); for such SI data items, the processor 312 arranges to store such items along with their time of receipt (as obtained from the clock 310) in data store 306. Concurrently with storing SI data items in the data store, the processor 312, for each stored data item, reads the corresponding time of receipt from the data store 306 and calculates the age of the stored SI data item with reference to the present time on the clock 310. The processor then compares the calculated age with a reference value obtained from either the program store 308 (for example, in the case where the reference value is fixed at the time of manufacture of the receiver) or the data store (for example, in the case where the reference value can be updated from time to time). Preferably, there would be more than one reference value, for example each corresponding to a particular type of SI data item, such as one for an SI data item belonging to a first SI table and a different reference value corresponding to a SI data item belonging to a second (different) SI table, sections of the first and second SI tables being repeated (sent to the receiver) at different time intervals. For example, for a DVB terrestrial (DVB-T) delivery system the reference value relating to an SI data item belonging to the EIT schedule table for the actual TS could (and preferably would) be different to the reference value relating to an SI data item belonging to an EIT schedule table for other TSs, since the DVB Guidelines propose that (where present) the EIT schedule table for the actual TS is repeated at least every 30 seconds whilst the EIT schedule table for other TSs is repeated at least every 300 seconds. In the case where the SI data item is too old compared to its reference value, the processor 312 arranges to delete the relevant SI data item and its corresponding time of receipt from the data store 306, thereby helping to ensure that stored SI data items remain reliable over time and available for use, without resorting to a total re-acquisition of SI data items of a particular type (for example all SI data items belonging to the EIT schedule table for the actual TS) thereby avoiding the corresponding delay and other performance drawbacks.

The foregoing method and implementation are presented by way of example only and represent a selection of a range of methods and implementations that can readily be identified by a person skilled in the art to exploit the advantages of the present invention.

In the description above and with reference to FIG. 1 there is disclosed a method for managing SI (Service Information) data stored within a receiver operable to receive digital AV (audio visual) content. The method comprises receiving 104 an SI data item; obtaining 106 the time of receipt and then storing 110 the data item and time of receipt. Concurrently, for each stored SI data item, the time of receipt of a stored SI data item is read 114; its age calculated 116 and compared 120 with a reference value; the stored SI data item is deleted 122 in dependence on the comparison. In this way obsolete data can be removed from the database without also removing valid data. By using a range of reference values according to the various types of SI data items, removal of obsolete data items can be further optimised to minimise the size of the database and reduce the likelihood of overlapping data items therein.

1. A method (100) for managing SI data stored within a receiver operable to receive digital AV content, the method comprising:
receiving (104) an SI data item;
obtaining (106) the time of receipt of the SI data item;
storing (110) the SI data item and its time of receipt; and
concurrently, for each stored SI data item:
reading (114) the time of receipt of the stored SI data item;
calculating (116) the age of the stored data item;
comparing (120) the calculated age with a reference value; and
deleting (122) the stored SI data item and its time of receipt in dependence on the comparison.

2. A method as claimed in claim 1, wherein the reference value is 15 minutes.

3. A method as claimed in claim 1, wherein the reference value is determined according to an estimated time interval between successive receptions of the identified SI data item.

4. A method as claimed in claim 3, wherein the receiver is DVB compliant and the estimate is based on DVB Guidelines on Implementation and usage of SI.

5. A method as claimed in claim 1, wherein the reference value is determined according to a measured time interval between successive receptions of the identified SI data item.

6. A method as claimed in claim 1 wherein the receiver is DVB compliant and SI data items comprise data items of DVB Event Information Tables.

7. A system (200) for managing SI data according to claim 1, the system comprising:
a transmitter (202) operable to transmit SI data; and
a receiver (204) operable to:
receive an SI data item;
obtain the time of receipt of the SI data item;
store the SI data item and its time of receipt; and
concurrently, for each stored SI data item:
read its time of receipt;
calculate the age of the stored data item;
compare the calculated age with a reference value; and
delete the stored SI data item and its time of receipt in dependence on the comparison.

8. A receiver (300) for use in the system of claim 7, comprising:
a tuner (304) operable to receive SI data items;
a clock (310);
a data store (306) operable to store received SI data items and, for each data item, its time of receipt;
a program store (308) operable to store program instructions; and
a processor (312), all interconnected by a data and control bus (314), the processor being operable, under control of the program instructions, to:
receive an SI data item from the tuner;
obtain time of receipt of the SI data item from the clock;
store the SI data item and its time of receipt in the data store; and
concurrently, for each stored SI data item:
read its time of receipt from the data store;
calculate the age of the stored data item;
compare the calculated age with a reference value; and
delete the stored SI data item and its time of receipt from the data store in dependence on the comparison.

9. A receiver as claimed in claim 8 wherein the receiver is DVB compliant.

10. A record carrier comprising software operable to carry out the method of claim 1.

11. A software utility configured for carrying out the method steps as claimed in claim 1.

12. A receiver as claimed in claim 8 wherein the processor is directed in its operations by a software utility configured for carrying out the method (100) for managing SI data stored within a receiver operable to receive digital AV content, the method comprising:
receiving (104) an SI data item;
obtaining (106) the time of receipt of the SI data item;
storing (110) the SI data item and its time of receipt; and
concurrently, for each stored SI data item:
reading (114) the time of receipt of the stored SI data item;
calculating (116) the age of the stored data item;
comparing (120) the calculated age with a reference value; and
deleting (122) the stored SI data item and its time of receipt in dependence on the comparison.
